(19) United States
(12) Patent Application Publication
(10) Pub. No.: US 2015/0113204 A1
(43) Pub. Date: Apr. 23, 2015

(54) DATA STORAGE DEVICE AND COMPUTING SYSTEM WITH THE SAME

(71) Applicants: National Chiao Tung University, Hsinchu City (TW); The Board of Trustees of the Leland Stanford Junior University, Palo Alto, CA (US)

(72) Inventors: Wing Hung Wong, Hsinchu City (TW); Tung-Yu Wu, Hsinchu City (TW); Chen-Yi Lee, Hsinchu City (TW); Hsi-Chia Chang, Hsinchu City (TW); Shu-Yu Hsu, Hsinchu City (TW); Chih-Lung Chen, Hsinchu City (TW); Chang-Hung Tsai, Hsinchu City (TW)

(21) Appl. No.: 14/056,066

(22) Filed: Oct. 17, 2013

(51) Int. Cl. G06F 3/06

(52) U.S. Cl. CPC G06F 3/0658; G06F 3/0604; G06F 3/0679
USPC 711/103

(57) ABSTRACT

A data storage device is in communication with a host through a bus. The data storage device includes a storage medium and a controlling unit. The controlling unit is connected with the host and the storage medium for receiving an analysis data, or storing a write data into the storage medium or retrieving a read data from the storage medium to the host according to a command from the host. The controlling unit includes an arithmetic logic unit. The arithmetic logic unit has a built-in algorithm for analyzing and processing the analysis data, the write data or the read data, thereby generating an analysis result. Moreover, the algorithm may be updated or expanded by the host.

### STATEMENT REGARDING GOVERNMENT SUPPORT

This invention was made with Government support under contract 1330132 awarded by the National Science Foundation. The Government has certain rights in this invention.

### FIELD OF THE INVENTION

The present invention relates to a data storage device and a data processing system, and more particularly to a data storage device and a computing system using the data storage device to perform big data analysis.

### BACKGROUND OF THE INVENTION

As is well known, a big data indicates a massive amount of data that are difficult to be analyzed and processed by a single computer within a reasonable time period. Generally, a distributed computing process is one of the most important computing techniques for analyzing and processing the big data.

Generally, the distributed computing process utilizes a massive amount of computing resources of the computer to process the big data. In practical applications, plural servers connected with a network are used to access and compute the allocated data, and the computing results of respective servers are transferred back to a computer of a data center through the network. After the computing results from all servers are received by the computer of the data center, the computer may analyze the computing results in order to analyze and process the big data.

Obviously, for analyzing and processing the big data through the network, the financially-strong large networking company has to purchase several ten thousands of servers to construct a massive computing resource in order to achieve the purpose of analyzing and processing the big data.

Therefore, it is important to use a single computer and a peripheral device to locally analyze and process the big data.

### SUMMARY OF THE INVENTION

An embodiment of the present invention provides a data storage device in communication with a host through a bus. The data storage device includes a storage medium and a controlling unit. The controlling unit is connected with the host and the storage medium for receiving an analysis data, or storing a write data into the storage medium or retrieving a read data from the storage medium to the host according to a command from the host. The controlling unit includes an arithmetic logic unit. The arithmetic logic unit has a built-in algorithm for analyzing and processing the analysis data, the write data or the read data, thereby generating an analysis result.

Another embodiment of the present invention provides a computing system. The computing system includes plural data storage devices and a host. Each of the plural data storage devices includes an arithmetic logic unit. The host is in communication with the plural data storage devices through plural buses for dividing a big data into plural sub-data and writing the plural sub-data into respective data storage devices. The arithmetic logic unit of each data storage device has a built-in algorithm for analyzing and processing the corresponding sub-data from the host and generating an analysis result to the host. The host generates a final analysis result according to plural analysis results obtained by the plural data storage devices.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic functional block diagram illustrating the relationship between a host and a solid state drive of a computing system;

FIG. 1B is a schematic functional block diagram illustrating the architecture of the controlling unit of the solid state drive used in the computing system of FIG. 1A;

FIG. 2 is a schematic functional block diagram illustrating the architecture of a solid state drive according to an embodiment of the present invention; and

FIG. 3 is a schematic functional block diagram illustrating the architecture of a computing system with plural solid state drives according to an embodiment of the present invention.

### DETAILED DESCRIPTION OF PREFERRED EMBODIMENTS

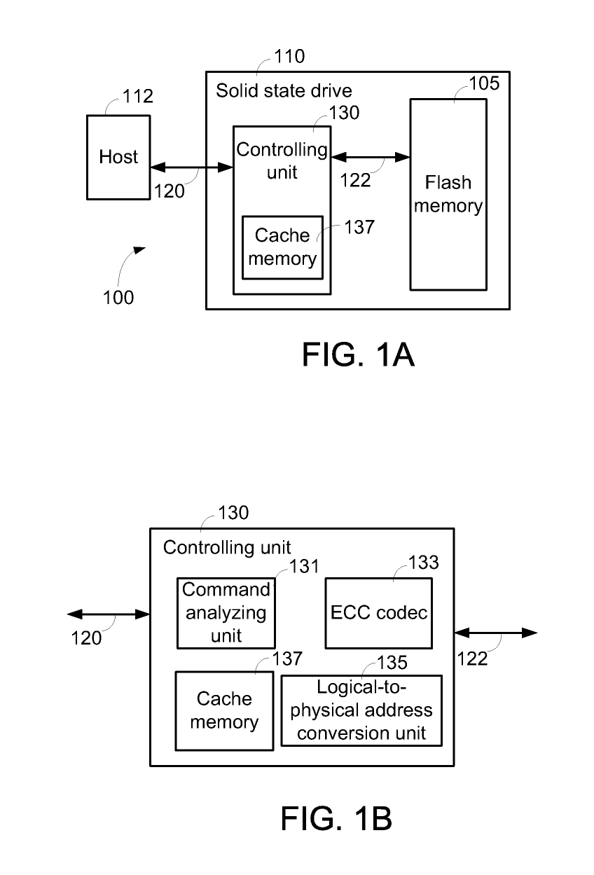

FIG. 1A is a schematic functional block diagram illustrating the relationship between a host and a solid state drive of a computing system. As shown in FIG. 1A, the computing system 100 comprises a host 112 and a solid state drive 110. The host 112 is in communication with the solid state drive 110 through an external bus 120. The host 112 at least comprises a central processing unit (not shown) and a chipset (not shown). The external bus 120 is a SATA bus, an USB bus, PCI-e, or the like.

Moreover, the solid state drive 110 comprises a controlling unit 130 and a flash memory 105. The controlling unit 130 is connected with the external bus 120. In addition, the controlling unit 130 is in communication with the flash memory 105 through an internal bus 122. The controlling unit 130 further comprises a cache memory 137. The cache memory 137 is a used for temporarily storing the write data from the host 120 or temporarily storing the read data to be read by the host 112. The cache memory 137 is for example a static random access memory (SRAM) or a dynamic random access memory (DRAM).

As shown in FIG. 1A, the cache memory 137 is included in the controlling unit 130. Alternatively, the cache memory 137 and the controlling unit 130 may be separate hardware circuits.

FIG. 1B is a schematic functional block diagram illustrating the architecture of the controlling unit of the solid state drive used in the computing system of FIG. 1A. As shown in FIG. 1B, the controlling unit 130 comprises a command analyzing unit 131, an error correction code (ECC) codec 133, a logical-to-physical address conversion unit 135, and the cache memory 137. In the computing system 100, the host 112 can access data of the solid state drive 110.

When the host 112 intends to write a write data into a specified logical block address (LBA), the host 112 may issue a write command, the specified logical block address (LBA) and the write data to the solid state drive 110. Meanwhile, the command analyzing unit 131 of the controlling unit 130 confirms that the write command is issued from the host 112, and the write data is temporarily stored in the cache memory 137. Then, the specified logical block address (LBA) is converted into a specified physical block address (PBA) by the logical-to-physical address conversion unit 135. The write data is encoded as an error correction code by the ECC codec 133. Afterwards, the encoded write data is written into the specified physical block address (PBA) of the flash memory 105.

When the host 112 intends to read a read data from the solid state drive 110, the host 112 may issue a read command and the specified logical block address (LBA) to the solid state drive 110. Meanwhile, the command analyzing unit 131 of the controlling unit 130 confirms that the read command is issued from the host 112. Then, the specified logical block address (LBA) is converted into a specified physical block address (PBA) by the logical-to-physical address conversion unit 135. Then, according to the specified physical block address (PBA), the encoded read data is retrieved from the flash memory 105. After the encoded read data is decoded by the ECC codec 133, the resulting read data is temporarily stored in the cache memory 137. Afterwards, the read data is outputted to the host 112.

From the above discussions about the computing system 100, the solid state drive 110 is only able to store the write data into the flash memory 105 according to the write command from the host 112 or output the read data to the host 112 according to the read command. Moreover, the controlling unit 130 is only able to encode the data as an error correction code or decode the encoded code. Obviously, the solid state drive 110 of the computing system 100 has no capability of analyzing and processing data.

For providing sufficient capability to the computing system of the present invention, the solid state drive of the present invention is equipped with an arithmetic logic unit (ALU). Consequently, the solid state drive has the capability to analyze and process data.

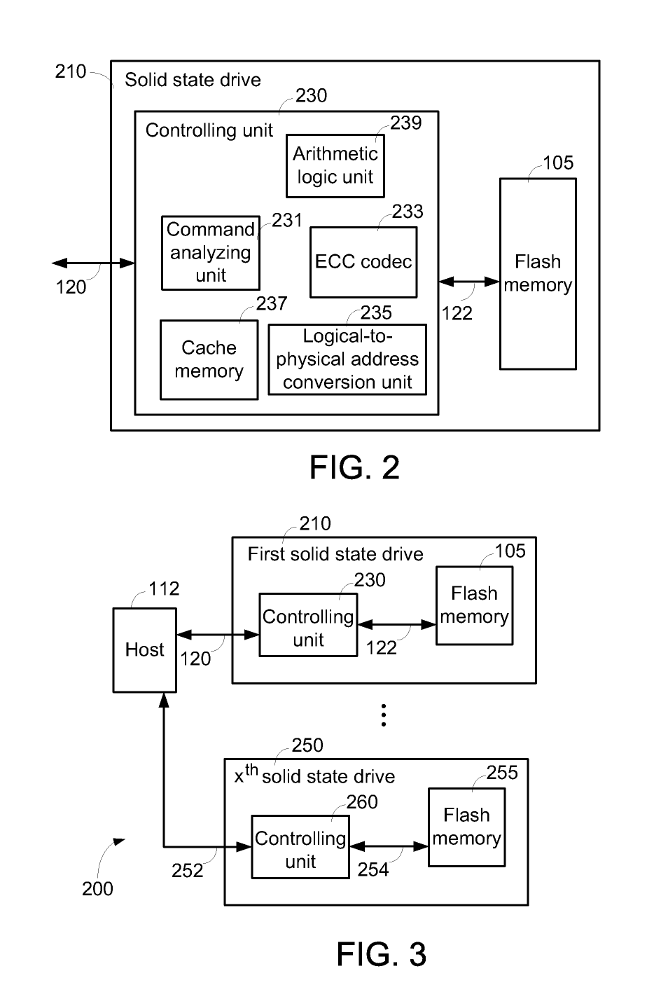

FIG. 2 is a schematic functional block diagram illustrating the architecture of a solid state drive according to an embodiment of the present invention. As shown in FIG. 2, the solid state drive 210 comprises a controlling unit 230 and a flash memory 105. The controlling unit 230 is in communication with a host (not shown) through an external bus 120. In addition, the controlling unit 230 is in communication with the flash memory 105 through an internal bus 122.

In this embodiment, the controlling unit 230 comprises a command analyzing unit 231, an error correction code (ECC) codec 233, a logical-to-physical address conversion unit 235, a cache memory 237, and an arithmetic logic unit 239.

During the process of accessing data of the solid state drive 210 by the host 112, the actions of the command analyzing unit 231, the ECC codec 233, the logical-to-physical address conversion unit 235 and the cache memory 237 are similar to those of FIG. 1B, and are not redundantly described herein.

In accordance with the present invention, the arithmetic logic unit 239 has a built-in algorithm for analyzing and processing the data of the flash memory 105. However, according to the practical requirements, an updated algorithm may be loaded from the host 112 into the arithmetic logic unit 239, so that the arithmetic logic unit 239 uses the updated algorithm to analyze and process the data of the flash memory 105. Of course, the algorithms for the arithmetic logic unit 239 may be expanded by the host 112 according to the practical requirements.

In an embodiment, after the write data is transmitted from the host 112 to the solid state drive 210 and before the write data is stored into the flash memory 105, the arithmetic logic unit 239 may use the built-in algorithm to analyze and process the write data, thereby generating an analysis result. Moreover, the analysis result is transferred back to the host 112 at an appropriate time point. Otherwise, the arithmetic logic unit 239 may store the analysis result into the flash memory 105.

Alternatively, before the read data is transmitted to the host 112, the arithmetic logic unit 239 may use the built-in algorithm to analyze and process the read data, thereby generating an analysis result. Moreover, the analysis result is transferred back to the host 112 at an appropriate time point. Otherwise, the arithmetic logic unit 239 may store the analysis result into the flash memory 105. Moreover, if the read data is a compressed data, the read data should be firstly decompressed and then analyzed and processed. For example, if the read data is a compressed video file in a H.264 compression format, the read data should be firstly subject to H.264 decompression and then analyzed and processed.

Alternatively, the host 112 may directly store all of the write data into the solid state drive 210 in advance. When no data accessing operation is performed on the solid state drive 210 by the host 112, the arithmetic logic unit 239 may use the built-in algorithm to analyze and process the write data stored in the flash memory 105, thereby generating an analysis result. Moreover, the analysis result is transferred back to the host 112 at an appropriate time point. Otherwise, the arithmetic logic unit 239 may store the analysis result into the flash memory 105.

Alternatively, if the host 112 needs the analysis result but does not need to write data into the solid state drive 210, the host 112 may issue an analysis data to the solid state drive 210. The arithmetic logic unit 239 may use the built-in algorithm to analyze and process the analysis data, thereby generating an analysis result. After the analysis result is generated by the arithmetic logic unit 239, the controlling unit 230 may directly discard the analysis data without the need of processing the analysis data. That is, the controlling unit 230 will not store the analysis data into the flash memory. Under this circumstance, the analysis result may be stored into the flash memory 105 or transferred back to the host 112 by the controlling unit 230.

In comparison with the amount of data stored in the flash memory 105, the data amount of the analysis result obtained by the arithmetic logic unit 239 is much smaller.

FIG. 3 is a schematic functional block diagram illustrating the architecture of a computing system with plural solid state drives according to an embodiment of the present invention. As shown in FIG. 3, the computing system 200 comprises a host 112 and plural solid state drives. For clarification and brevity, only two solid state drives 210 and 250 are shown in the drawing. The configuration of each of the solid state drives 210 and 250 is identical to that of the solid state drive 210 of FIG. 2. The solid state drive 210 comprises a controlling unit 230 and a flash memory 105. The solid state drive 250 comprises a controlling unit 260 and a flash memory 255.

When the host 112 of the computing system 200 intends to analyze a big data, the big data may be divided into plural sub-data, and the sub-data are transmitted to the solid state drives 210 and 250, respectively. In the computing system 200 of FIG. 3, the two solid state drives 210 and 250 are in communication with the host 112. Before the big data is analyzed by the host 112, the big data is divided into a first sub-data and a second sub-data. The first sub-data is transmitted to the solid state drive 210. The second sub-data is transmitted to the solid state drive 250.

The controlling unit 230 of the solid state drive 210 may use the algorithm to analyze and process the first sub-data, thereby generating a first analysis result. The controlling unit 260 of the solid state drive 250 may use the algorithm to analyze and process the second sub-data, thereby generating a second analysis result. After the first analysis result of the solid state drive 210 and the second analysis result of the solid state drive 250 are acquired by the host 112, the final analysis result of the big data analysis is produced.

From the above discussions about the computing system 200, the plural solid state drives in communication with host 112 are used for analyzing and processing respective sub-data. More especially, the plural solid state drives may process respective sub-data in a parallel processing manner to obtain respective analysis results without the need of exchanging the sub-data between each other. In other words, the host 112 can generate the final analysis result of the big data analysis by simply combining the analysis results of the plural solid state drives together. It is noted that numerous modifications and alterations may be made while retaining the teachings of the invention. For example, during the analyzing processes of the solid state drives 210 and 250, the analysis results of the solid state drives 210 and 250 may be exchanged through the host 112.

In addition, as the size of the big data increases, the number of the solid state drives included in the computer system 200 may correspondingly increase. Consequently, the computer system 200 of the present invention can quickly and locally perform the big data analysis without the need of connecting to the remote serves through network connection.

The above embodiments are illustrated by referring to the computing system with the solid state drive and the host. It is noted that the data storage device used in the computing system is not restricted to the solid state drive. However, those skilled in the art will readily observe that any other data storage device with similar functions of the solid state drive may be used in the computing system of the present invention. For example, an optical disc drive, a hard disc drive, a read-only memory or a resistive random-access memory (RRAM) with a resistive non-volatile memory may be used as the data storage device.

In case that the optical disc drive is used as the data storage device, the optical disc drive comprises a controlling unit and a storage medium. The storage medium is an optical disc. If the controlling unit comprises an arithmetic logic unit, the arithmetic logic unit may use a built-in algorithm to analyze and compute the data of the optical disc, thereby generating an analysis result. Of course, the data in the optical disc (i.e. the storage medium) may be originated from the host, and transmitted from the host to the optical disc drive and stored in the optical disc. Alternatively, the analysis data may be previously written into the optical disc by using another computer system. After the optical disc is loaded into the optical disc drive, the analysis data is processed according to the algorithm.

In case that the hard disc drive is used as the data storage device, the hard disc drive comprises a controlling unit and a storage medium. The storage medium is a magnetic disc. If the controlling unit comprises an arithmetic logic unit, the arithmetic logic unit may use a built-in algorithm to analyze and compute the data of the magnetic disc, thereby generating an analysis result. Moreover, the data in the hard disc drive may be a sub-data that is divided by and transmitted from a host of another computing system. After the hard disc drive is in communication with the host of the computing system of the present invention, the data is analyzed and processed to generate the analysis result.

Moreover, the built-in algorithm of the controlling unit of the data storage device may be updated or expanded by the host. In other words, for analyzing other big data, the algorithm may be reduced into plural sub-algorithms. After the built-in algorithm is replaced by the sub-algorithms, the computing system may use the same hardware architecture to analyze another big data.

The arithmetic logic unit of the controlling unit may be implemented by a software component, a firmware component or a hardware component. For example, the hardware component is a programmable logical array (PLA) or a field-programmable gate array (FPGA). Of course, the arithmetic logic unit may be implemented by a hardware component along with a software component or a firmware component. The arithmetic logic unit is included in the solid state drive and close to the flash memory. Consequently, the process of performing big data analysis is very efficient.

From the above descriptions, the present invention provides a computing system. The computer system comprises a host and plural data storage device. Consequently, the computing system can quickly and locally perform the big data analysis without the need of connecting to the remote serves through network connection.

The controlling unit of each data storage device is equipped with an arithmetic logic unit. The arithmetic logic unit is used to analyze and process the data of the data storage device, thereby generating an analysis result and providing the analysis result to the host. In comparison with the amount of data stored in the data storage device, the data amount of the analysis result is much smaller. Consequently, the burden of processing the data by the host is largely reduced. Moreover, by increasing the number of data storage devices, the computing system of the present invention is effective to perform the big data analysis. Moreover, it is not necessary to exchange data or information between the plural data storage devices during the analyzing process of the arithmetic logic units. Consequently, when the number of the data storage devices increases, the processing time is not increased at an exponential growth rate.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data storage device in communication with a host through a bus, the data storage device comprising:
a storage medium; and
a controlling unit connected with the host and the storage medium for receiving an analysis data, or storing a write data into the storage medium or retrieving a read data from the storage medium to the host according to a command from the host,
wherein the controlling unit comprises an arithmetic logic unit, and the arithmetic logic unit has a built-in algorithm for analyzing and processing the analysis data, the write data or the read data, thereby generating an analysis result.

2. The data storage device as claimed in claim 1, wherein the analysis data is previously stored in the storage medium, wherein after the storage medium is loaded into the data storage device, the analysis data is analyzed and processed by the controlling unit according to the algorithm.

3. The data storage device as claimed in claim 1, wherein the analysis data is transmitted from the host to the controlling unit.

4. The data storage device as claimed in claim 1, wherein the analysis result is transmitted to the host or written into the storage medium.

5. The data storage device as claimed in claim 1, wherein the storage medium is a flash memory, a resistive non-volatile memory, an optical disc or a magnetic disc.

6. The data storage device as claimed in claim 1, wherein when the host provides an updated algorithm to the arithmetic logic unit, the built-in algorithm is replaced by the updated algorithm.

7. The data storage device as claimed in claim 1, wherein the arithmetic logic unit is implemented by a firmware component, a software component or a hardware component, or the arithmetic logic unit is implemented by the hardware component and the firmware component or the software component, wherein the hardware component is a programmable logical array or a field-programmable gate array.

8. The data storage device as claimed in claim 1, wherein the write data is analyzed and processed by the arithmetic logic unit when the write data is received by the arithmetic logic unit, or the read data is analyzed and processed by the arithmetic logic unit when the read data is received by the arithmetic logic unit.

9. The data storage device as claimed in claim 8, wherein if the read data is a compressed data, the read data is firstly decompressed and then analyzed and processed by the arithmetic logic unit.

10. The data storage device as claimed in claim 1, wherein the host generates a final analysis result according to the analysis result.

11. A computing system, comprising:
plural data storage devices, wherein each of the plural data storage devices comprises an arithmetic logic unit; and
a host in communication with the plural data storage devices through plural buses for dividing a big data into plural sub-data and writing the plural sub-data into respective data storage devices, wherein the arithmetic logic unit of each data storage device has a built-in algorithm for analyzing and processing the corresponding sub-data from the host and generating an analysis result to the host, wherein the host generates a final analysis result according to plural analysis results obtained by the plural data storage devices.

12. The computing system as claimed in claim 11, wherein the data storage device is a solid state drive a resistive random-access memory, an optical disc drive, a hard disc drive or a read-only memory.

13. The computing system as claimed in claim 11, wherein when the host provides an updated algorithm to the arithmetic logic unit, the built-in algorithm is replaced by the updated algorithm.

14. The computing system as claimed in claim 11, wherein the arithmetic logic unit is implemented by a firmware component, a software component or a hardware component, or the arithmetic logic unit is implemented by the hardware component and the firmware component or the software component, wherein the hardware component is a programmable logical array or a field-programmable gate array.

15. The computing system as claimed in claim 11, wherein no data is exchanged between the plural arithmetic logic units of the plural data storage devices while the corresponding sub-data are analyzed and processed.

16. The computing system as claimed in claim 11, wherein the plural analysis results obtained by the plural data storage devices are permitted to be exchanged between each other.
